(19) United States
(12) Patent Application Publication
(10) Pub. No.: US 2005/0197853 A1
(43) Pub. Date: Sep. 8, 2005

(54) Grading system, server computer, computer, card case, card and program

(75) Inventor: Takashi Ueno, Tokyo (JP)

Correspondence Address: OLIFF & BERRIDGE, PLC, P.O. BOX 19928, ALEXANDRIA, VA, 22320, US

(73) Assignee: R & B 21, Tokyo (JP)

(21) Appl. No.: 11/049,709

(22) Filed: Feb. 4, 2005

(30) Foreign Application Priority Data
Feb. 9, 2004 (JP) 2004-31934
Jun. 24, 2004 (JP) 2004-185945

(51) Int. Cl. G06F 17/60

(52) U.S. Cl. 705/1

(57) ABSTRACT

A grading system includes a server computer installed in a management company and a client computer owned by a client and connected to the server computer via a network. Through a scanner etc., the client computer reads the condition information of the card and transmits the information to the server computer. The server computer appraises the card and transmit an appraisal result to the client computer. The client computer registers the appraisal result in the card. The client computer reads the card information stored in the card on demand and transmits the information to the server computer connected to the network. The server computer updates the card information via the network. The server computer intermediates the card trading (the transfer of a card and the accounting procedure).

### BACKGROUND OF THE INVENTION

Field of the Invention

The present invention relates to a grading system for managing the appraisal information, evaluation information and related information of trading cards via a network such as the Internet.

Recently, not only card collectors in Japan but also card collectors in other countries throughout the world have exchanged, sold, and purchased trading cards among themselves.

A trading card (hereinafter simply referred to as a “card”) is a card on which a photograph of a professional athlete such as a baseball player, a soccer player and basketball player etc., a picture of a character of an animated program, a photograph or scene of a movie cast, or a photograph of an idol is printed. The card includes a game card. It is possible to include in a card a texture of a jersey dressed in by a professional athlete or his/her autograph.

And it is possible to store auditory information, visual information and textual information in built-in IC chips etc. of a card. A card of limited publication or a rare card is traded at a high price among collectors. The appraisal company appraises the condition of a card for sale and casts remarks of several grades as itemized and synthetic evaluation. This ranking of a card is usually called as “grading” and a graded card included in a card case and sealed is called as a grading card. The said card case, even if not sealed, is sometimes used in order to prevent a card from being damaged, deteriorated or stained and to maintain the conditions of a card.

Moreover there is a card information magazine called as a price guidebook published periodically for each genre of a card. A price guidebook includes a price as a standard for the exchange and trading of a card.

The patent document 1 relates to a patent regarding a card wherein a window is provided and wherein the window portion is provided with a lamination (a texture of a uniform of a professional athlete, a texture of clothes dressed in by a talent and a slip of his/her autograph) related to a theme of a card.

The patent document 2 relates to a patent to store in a card or reproduce from a card the visual or auditory information etc. and to embody bidirectional communication between a character on a card and a owner of a card.

Remarks:

The patent document 1: Japanese Patent Publication No. 79781 of 2002.

The patent document 2: Japanese Patent Publication No. 49312 of 2002.

With a trend toward global trading of cards, the distance between parties who trade or exhange a card has increased, making direct checking of the conditions of the card difficult.

Moreover, due to recent progress of, for example, the Internet technique, cards are sometimes sold at an auction on the network. However buyers encounter difficulty in grasping the conditions of a card.

An owner of a card should consult a periodically published price guidebook in order to know the rated price of his/her own card.

Moreover, an owner of a card should bring the card in person (or send the card) to the card management company when changing the appraisal information and owner information both of which were stored in the card. Therefore an accident (loss or damage etc.) could happen during the transportation of a card.

An owner of a card could not read out the card information stored in his/her own card and by the card management company directly on the terminal device owned by the said owner of a card nor add nor update the card information.

### SUMMARY OF THE INVENTION

In view of the foregoing, an object of the present invention is to provide a trading system which enables card collectors to trade and store cards safely and efficiently.

In order to achieve the above objects, according to a first aspect of the present invention, there is provided a grading system, comprising a server computer connected to a network; and a client computer with a card reading&writing terminal device connected to a network, wherein the server computer includes means to receive an appraisal result of a card read out by the card reading&writing terminal device and transmitted by the client computer and means to transmit a rated price of a card evaluated from the appraisal result of a card to the client computer; and means to input the rated price of a card in the card by use of the card reading&writing terminal device.

The server computer includes means to transmit card information to be added or updated in the client computer via the network; and means to input the said card information in the card via the network.

And the said server computer includes means to authenticate the card the client computer reads by use of the card reading&writing terminal device; and means to transmit the said card information to the client computer on the demand of the client computer.

The said card stores in the memory portion appraisal result of a card; owner information of the card; and appraisal amount of the card; and other information of the card.

The said server computer stores in the memory portion appraisal result of a card; owner information of the card; and appraisal amount of the card; and other information of the card.

The server computer is installed e.g. at the card management company etc. conducting card appraisal business etc.

A card reading&writing terminal device reads and writes card information on the contact or non-contact basis, connected to a computer of an owner of a card. Card information is transmitted and received between the said computer of the owner of the card and the server computer via a network.

A computer provided with a card reading&writing terminal device may be a portable terminal device provided with card reading&writing function. A portable terminal device needs no fixed place for installation such as cellular telephone, PDA (Personal Digital Assistant), handheld computer. A portable terminal device can be connected to a server computer via a network, wired or wireless.

In the grading system according to a first aspect of the present invention the server computer sends a rated price judged from an appraisal result of a card transmitted from a client computer of the owner of a card back to the said client computer to input the rated price in the card, by use of a card reading&writing terminal device. Moreover the server computer transmits addition of card information and updated information to the client computer; and writes the said information in the card by use of the card reading&writing terminal device; and transmit card information from the server to the client computer of an owner of a card on the demand of the owner of a card.

According to a second aspect of the present invention, there is provided a grading system, comprising a server computer connected to a network; and a client computer provided with a card reading&writing terminal device connected to the network, wherein the server computer includes means to appraise the card; and means to transmit an appraisal result to the client computer based on the information about a condition of a card to input the appraisal result in the card by use of the card reading&writing terminal device.

In the grading system of a second aspect, a server computer appraises a card based on a condition of a card sent from an owner of a card through a scanner etc.; and transmit this appraisal result to the client computer of an owner of a card to input this appraisal result in the card by use of a card reading&writing terminal device.

According to a third aspect of the present invention, there is provided a grading system, comprising a server computer connected to a network; and a client computer provided with a card reading&writing terminal device connected to the network, wherein the server computer transmits an appraisal result of the card etc. to the first computer of an aspirant to buy a card, when the said first computer requests reference of information about the card; and informs the second computer of an owner of a card of a request for purchase from the said first computer to intermediate the trading; and stores updating of owner information of the card etc., when the trading is concluded and an owner of the card is changed.

In the grading system of a third aspect, a server computer transmits an appraisal result of a card to the first computer, when the first computer of an aspirant to buy a card requests reference of information about the card; and informs the second computer of an owner of the card of a request for purchase from the said first computer to intermediate the trading; and stores a change of owner information of the card etc., when the trading is concluded and an owner of the card is changed.

According to a fourth aspect of the present invention, there is provided a grading system, comprising a server computer connected to a network; and a client computer provided with a card reading&writing terminal device connected to the network, wherein the client computer includes means to read card information stored in the server computer; and means to update and add the said card information stored in the server computer.

In the grading system of a fourth aspect, the client computer can read card information stored on a server computer; and update and add card information stored in the server computer, i.e. an owner of a card can confirm information about the card of his/her own; and update and add the said information. Moreover the client computer includes a portable terminal device.

According to a fifth aspect of the present invention, there is provided a grading system, comprising a server computer connected to a network; and a client computer provided with a card reading&writing terminal device connected to the network, wherein the client computer includes means to read information stored in the card; and means to update and add the said information stored in the card.

In the grading system of a fifth aspect, the client computer can read information stored in a card; and update and add card information stored in the card, i.e. an owner of a card can confirm information about the card of his/her own; and update and add the said information stored in his/her own card. Moreover the client computer includes a portable terminal device.

According to a sixth aspect of the present invention, there is provided a server computer connected to a client computer provided with a card reading&writing terminal device via a network, wherein the client computer includes means to receive an appraisal result of a card transmitted from the client computer of an owner of a card by use of a card reading&writing terminal device reading a card; and means to transmit rated price of the card judged from an appraisal result of a card to the client computer to input the rated price in the card by use of the card reading&writing terminal device.

According to a seventh aspect of the present invention, there is provided a server computer connected to a client computer provided with a card reading&writing terminal device via a network, wherein the server computer includes means to appraise the card based on the information about a condition of a card; and means to transmit an appraisal result to the client computer to input the rated price in the card by use of the card reading&writing terminal device.

According to a eighth aspect of the present invention, there is provided a server computer connected to a client computer provided with a card reading&writing terminal device via a network, wherein the server computer transmits an appraisal result of the card etc. to the first computer of an aspirant to buy a card, when the said first computer requests reference of information about the card; and informs the second computer of an owner of a card of a request for purchase from the said first computer to intermediate the trading; and stores updating of owner information of the card etc., when the trading is concluded and an owner of the card is changed.

According to a ninth aspect of the present invention, there is provided a client computer connected to a server computer via a network, wherein the client computer includes means to read card information stored in the server computer; and means to update and add the information about the card stored in the server computer.

According to a tenth aspect of the present invention, there is provided a client computer connected to a server computer via a network, wherein the client computer includes means to read information stored in the card; and means to update and add the information about the card stored in the card.

According to an eleventh aspect of the present invention, there is provided a card case, having a card accommodation space for accommodating a card, and an IC chip accommodation space for accommodating a memory medium such as an IC chip etc.

In the card case of an eleventh aspect, it is desirable that the memory medium such as an IC chip etc. stores an appraisal result of the card, owner information of the card, and other information about the card. Moreover, a memory medium may comprise a memory area enabling an input of information (visual information, textual information etc.) as other information about the card on the personal basis by e.g. an owner of the card. Moreover a card case may include a material attenuating ultraviolet rays radiated over the card.

According to a twelfth aspect of the present invention, there is provided a card, comprising a memory medium such as IC chip etc., wherein the memory medium stores an appraisal result of a card; and owner information of the card; and a rated price of the card; and other information of the card.

Moreover a card may be coated with a material attenuating ultraviolet rays.

According to a thirteenth aspect of the present invention, there is provided a program to let a server computer function as any grading system from claim 1 to claim 7.

The program according to a thirteenth aspect of the present invention makes a server computer function as any grading system from claim 1 to claim 7 wherein this program can be distributed via a network.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompany drawings, in which:

FIG. 1 is a block diagram showing a grading system according to an embodiment of the present invention;

FIG. 2 is a block diagram showing the configuration of a server computer of a card management company.

FIG. 3 is a block diagram showing the configuration of a client computer.

FIG. 4 is an exploded perspective view of the structure of a card case; and a card.

FIG. 5 is a perspective view showing the card case in which a body case and a lid are assembled closely.

FIG. 6 is a view showing the structure of an IC chip.

FIG. 7 is a table showing card information.

FIG. 8 is a flowchart showing the storage of an appraisal result of a card; and the storage of a rated price of a card.

FIG. 9 is a flowchart showing the updating of card information.

FIG. 10 is a flowchart showing the transmission of card information at the request of a client.

FIG. 11 is a flowchart showing the trading of a card.

FIG. 12 is a flowchart showing the tranmission of card information from a client.

FIG. 13 is a flowchart showing the process of referring and updating card information in a server computer by a client.

FIG. 14 is a flowchart showing the process of referring and updating card information in a card by a client.

FIG. 15 is a block diagram showing a grading system by use of a portable terminal device.

FIG. 16 is a block diagram showing the configuration of a portable terminal device.

### DESCRIPTION OF THE PREFERRED EMBODIMENT

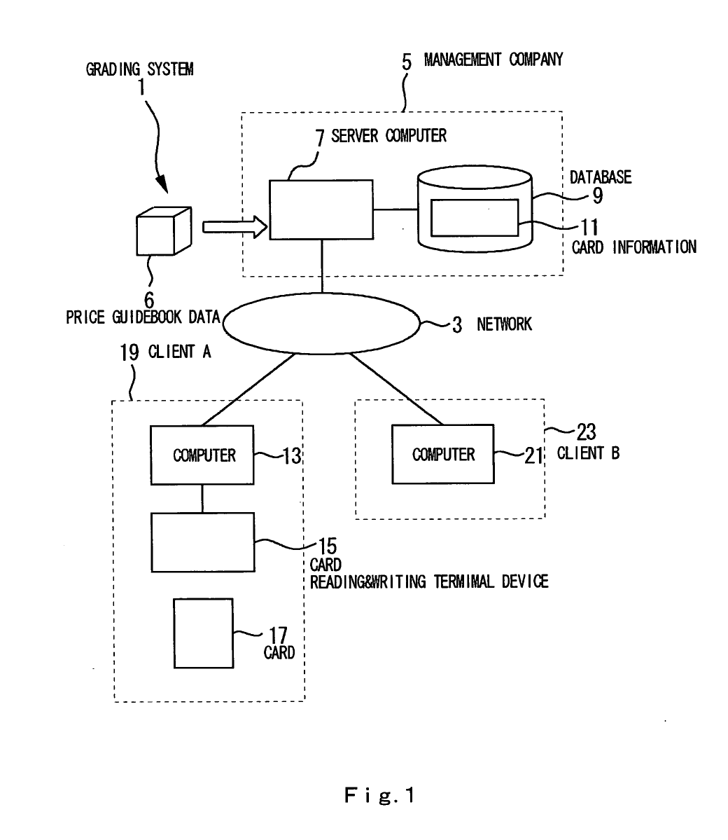

An embodiment of the present invention will now be described in detail with reference to the drawings. FIG. 1 is a block diagram showing a grading system according to an embodiment of the present invention.

Here, the term “grading” means appraising and ranking a card.

(1. Configuration)

(1-1. The Configuration of the Grading System 1)

The grading system 1 includes a network 3, a server computer 7, a client computer 13, and a client computer 21.

The server computer 7 is connected to the network 3 and is disposed in a management company 5 etc. The management company 5 performs card appraisal, management business of card information, and intermediation of card trading etc. The server computer 7 has a database 9 wherein the database 9 holds information 11. The card information 11 includes, however its details are mentioned later, for each card, a card type, information regarding the owner of the card, appraisal result of the card, and the rated price etc.

A price guidebook is a periodically issued (e.g. monthly) information magazine for the rated price of a card by the genre. A price guidebook includes the price for a standard to exchange and trade a card wherein the management company 5 judges a rated price (the assessed price) of a card. The price guide data 6 according to the FIG. 1 means the rated price of a card included in the price guidebook.

The client computer 13 is owned by a client A and is connected to the network 3. The client computer 13 is connected to the network 3. The client computer 13 is connected to the card reading&writing terminal device 15. The card reading&writing terminal device 15 has the function to write and read information in the card 17 owned by a client A. The card reading&writing terminal device on the contact basis contacts the terminal connected to the memory portion (the below-mentioned IC chip etc.) of the card 17, and that on the non-contact basis contacts scans the memory portion of the card 17 by use of infrared rays or laser diodes etc. to read and write data.

The client computer 21 is owned by a client B, connected to the network 3. Here, the client B is regarded as an aspirant to buy a card.

(1-2. The Configuration of the Server Computer 7 and the Client Computer 13)

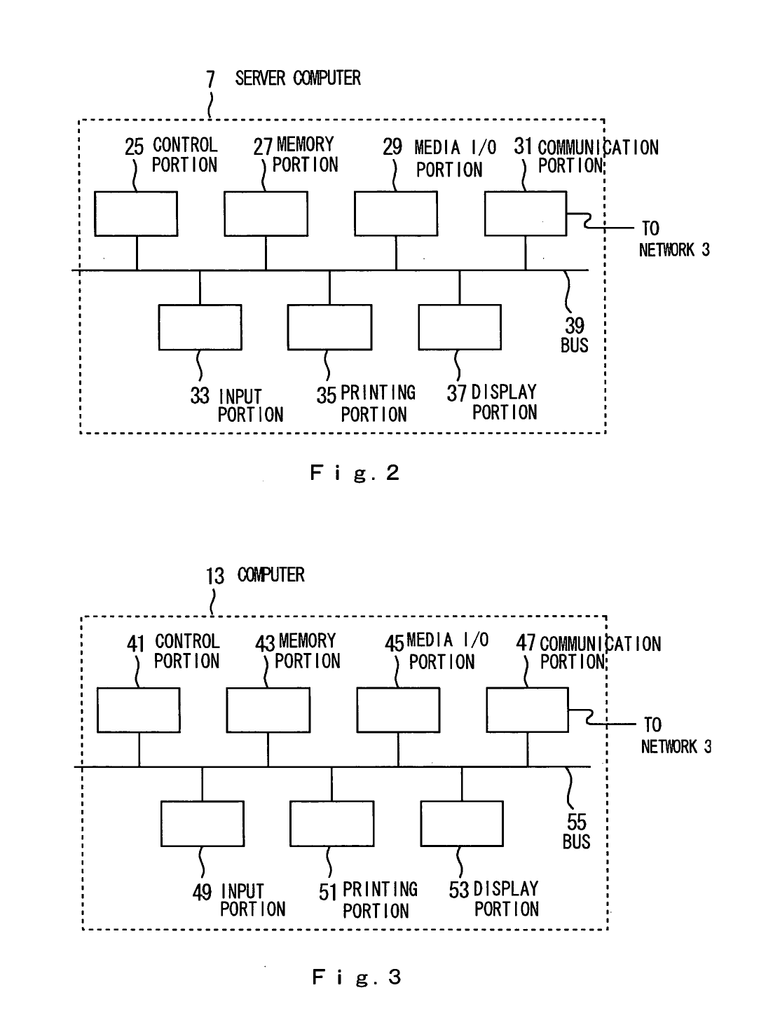

FIG. 2 shows the configuration of the server 7 and FIG. 3 shows the configuration of the client computer 13.

In FIG. 2, the server computer 7 includes the control portion 25 such as a central processing unit etc., the memory portion 27 such as a HDD etc., the media input/output 29 to read and write in the media such as a flexible disc or CD-ROM etc., the communication portion 31 such as a modem or a LAN board etc. connected to the network 3, the input portion 33 such as a keyboard or mouse etc., the printing portion 35 such as a printer etc., and the display portion 37 such as a CRT or liquid crystal display device, each of which is connected through the bus 39.

The configuration of the client computer 13 is the same as that of the server computer 7, therefore its explanation is omitted. The card reading&writing terminal device 15 is connected to the bus 55 of the client computer 13. The explanation for the computer 23 of the client B is also omitted owing to the similar configuration.

(1-3. The Configuration of the Card Case 57)

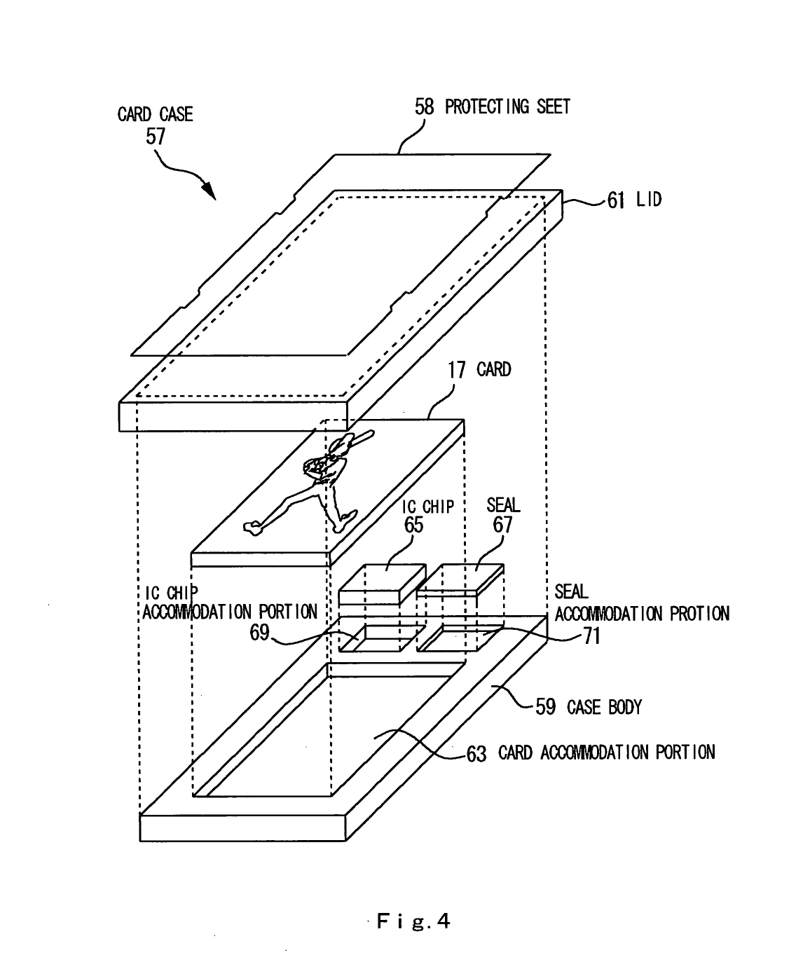

FIG. 4 shows the card case 57 accommodating the appraised card 17. The card 17 is appraised by the management company 5. The appraisal of the card 17 by means of four items; i.e., center, corners, edges, and surface. Specifically, the management company 5 evaluates each item, determines an evaluation point of each item, and determines an overall evaluation point. This appraisal is performed by use of a special testing device (not shown).

The appraised card 17 is accommodated in a card case 57. The card case 57 consists of a case body 59, a lid 61, and a protecting sheet 58.

The case body 59 assumes a plate-like shape, and formed on the case body 59 are a card accommodation portion 63, an IC chip accommodation portion 69, and a seal accommodation portion 71, each assuming the form of rectangular. An IC chip 65 storing information about this card 17 is accommodated in the card accommodation portion 69. A seal 67 with a print about the card 17 is accommodated (or sealed) in the seal accommodation portion 71. A protecting sheet 58 is attached to a lid 61. The protecting sheet 58 guards the autograph of an athlete written on the lid 61, and the print against stain and breakage. The protecting sheet 58, if provided with ultraviolet processing, attenuates deterioration by ultraviolet rays of the autograph of an athlete written on the lid 61, and the print on the card 17.

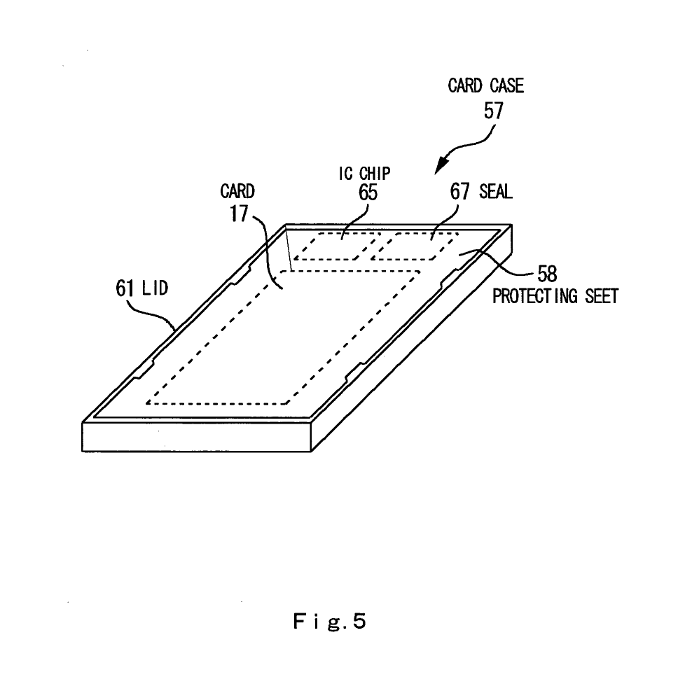

FIG. 5 shows the card case 57 in which the case body 59 and the lid 61 are joined closely. The card 17 is accommodated in the card accommodation portion 63, The IC chip 65 is accommodated in the IC chip accommodation portion 69. The seal 67 is accommodated in the seal accommodation portion 71. Subsequently, the lid 61 is placed on the case body 59. By use of a special apparatus (not shown), the case body 59 and the lid 61 are completely welded together by means of ultrasonic waves so as to protect the card 17, the IC chip 65 etc. The protecting sheet 58 is attached as if inserted into the lid 61. The card case 57 may be fixed in a openable condition, not joined closely by use of a special apparatus so as to protect and hold the card 17 etc.

The case body 59, the lid 61, and the protecting sheet 58 are formed of a transparent, hard material, such as acrylic plate, so that the card 17, the IC chip 65 and the seal 67 can be viewed from the upper side (shown in FIG. 3) and from the lower side (shown in FIG. 4) of the card body 59 and the lid 61. The surface of the card body 59, and the lid 61 can be provided with the surface processing enabling an autograph and a seal of an athlete etc.

The deterioration of the autograph and the print of the card 17 is caused by the ultraviolet rays radiated from the natural rays and fluorescent light etc. In order to prevent deterioration owing to the ultraviolet rays, the part or whole of the lid 61, the case body 59, and the protecting sheet 58 each comprising the card case 57 can be provided with the processing for protection against ultraviolet rays. The said processing means the processing to add chemical substance of ultraviolet rays absorbent to the materials of the lid 61, the card body 59, and the protecting sheet 58 in making; and the processing to provide coating the chemical substance of ultraviolet rays absorbent on the surface.

There is a chemical substance to change ultraviolet ray cut ratio according to the outer brightness, the same as a changeable lens. In some cases this chemical substance can be added to the material of the case body, the protecting sheet, or the appendage such as the case cover etc. to change the material itself. This chemical substance can be used for the coating processing or sealing processing on the surface of the case body, the protecting sheet, or the appendage such as the case cover etc. In some cases the card 17 itself is provided with the coating for ultraviolet ray protection.

In FIG. 5 the IC chip accommodation portion 69 and the seal accommodation portion 71 are provided respectively, however both can be accommodated together e.g. by inserting the IC chip 65 between the seal 67 and the seal accommodation portion 71. The card 17, the IC chip 65, and the seal 67 etc. can be accommodated together in the card accommodation portion 63.

(1-4. IC Chip 65)

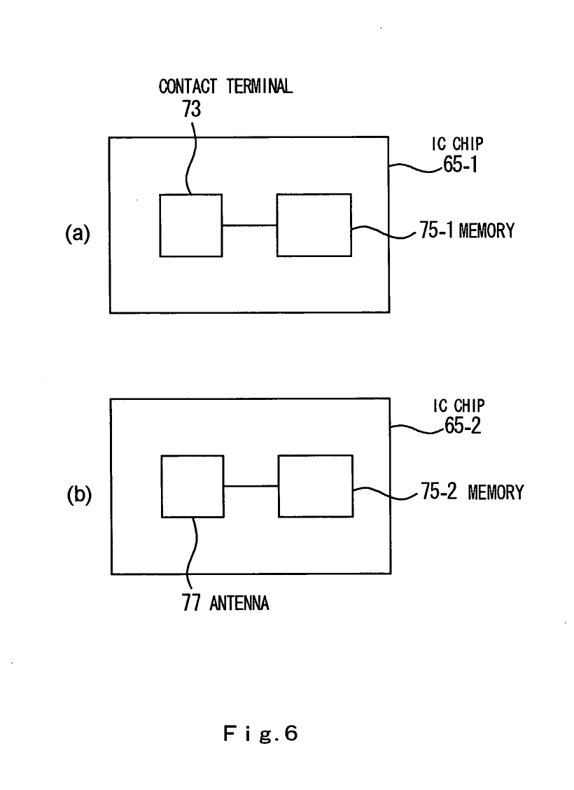

The card information 11 of the card 17 and other data are stored in the IC chip 65. FIG. 6 shows the structure of the IC chip 65. FIG. 6(a) shows the IC chip 65-1 having a contact terminal 73. The data is stored in the memory 75-1 as the memory portion or in case of reading data from the memory 75-1, the contact terminal 73 is connected to the external equipment to communicate information. FIG. 6(b) shows the non-contact-type IC chip 65-2. In this case, the data is stored in the memory 75-2 to communicate information or the data is read from the memory 75-2, each by use of the card reading&writing terminal device and the electric wave through the antenna 77.

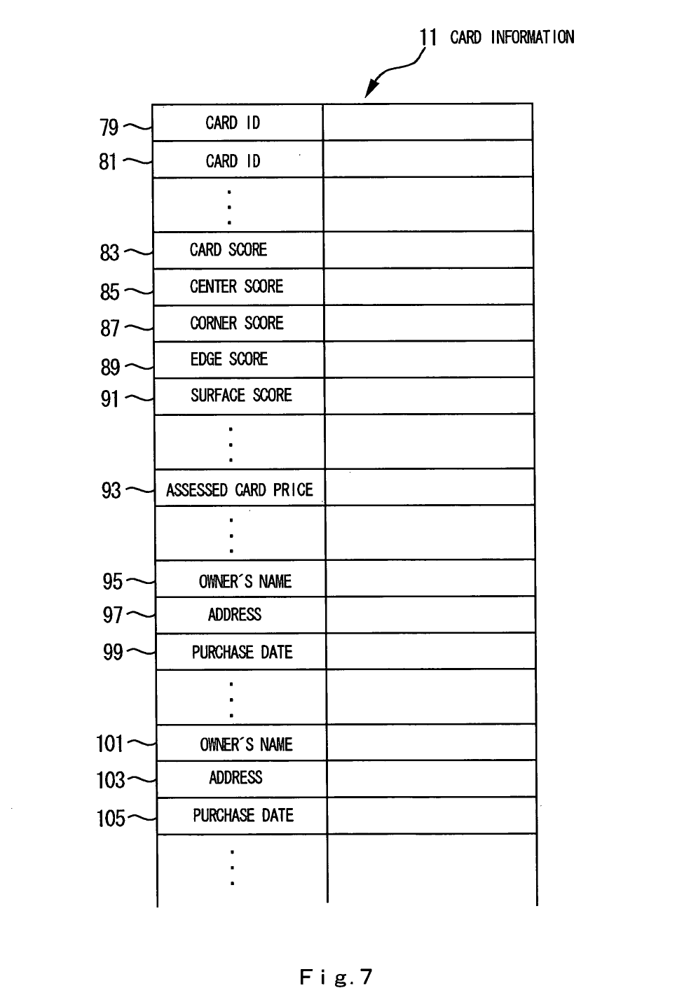

The card information 11 of the card 17 and other data are stored in the IC chip 65. FIG. 7 shows the card information 11. The card information 11 includes a card ID 79, card name 81, a card score 43, a center score 85, a corner score 87, an edge score 89, a surface score 91, a card rated price 93, an owner's name 95, an address 97, a purchase date 99, etc.

The card ID 79, the card name 81, etc., are items for representing a card type. The card ID 79 is an identification number of the card 17. The card name 81 is the name, for example, a professional athlete whose picture is printed on the card 17. The items such as the card issuance date etc. can be included.

The card score 83, the center score 85, the corner score 87, the edge score 89, the surface score 91, etc. are items regarding the appraisal result of the card 17. The center score 85 represents an evaluation point regarding a center portion of the card 17; the corner score 87 represents an evaluation point regarding corners of the card 17, the edge score 89 represents an evaluation point regarding edges of the card 17, the surface score 91 represents an evaluation point regarding surfaces of the card 17; and the card score 83 represents an overall evaluation point of the card 17.

The card rated price 93 is the rated price for trading with reference to the card score 83 signifying the appraisal result of the card 17; and with reference to the data of the card 17 according to the card type included in the price guidebook.

The owner's name 95, the address 97, the purchase date 99, etc. and the owner's name 101, the address 103, the purchase date 105, etc. are information items regarding the past and present owners of the card 17. For example, the information regarading the client A, who is the present owner, is stored in the rows corresponding to the owner's name 95, the address 97, the purchase date 99, etc.; and the information regarding a person who owned the card 17 previous to the client A is stored in the rows corresponding to the owner's name 101, the address 103, the purchase date 105, etc.

As described above, the card information 11 is stored in the IC chip 65. In other words, through reading the IC chip 65, the card type, the appraisal result, the rated price, and the history of ownership can be obtained. Moreover the card information 11 can be stored not only as the textual information but also as the auditory and/or visual information (animated and/or still pictures).

In the IC chip 65, for example, the information (textual information, still picture, voice, animated picture etc.) of a professional athlete whose picture is printed on the card 17 can be stored.

In the IC chip 65, the memory area for the storage of personal information of an owner of the card 17. In other words, the owner of the card can store and preserve textual information and visual information in the IC chip 65.

The flash memory and other media that are more massive memory can be used for the memory unit of the card information 11.

Information necessary for checking the card 17, such as the card type and evaluation points representing the appraisal result, is described on the seal 67. The seal 67 may be omitted if the client A so wishes.

(2. Flowchart)

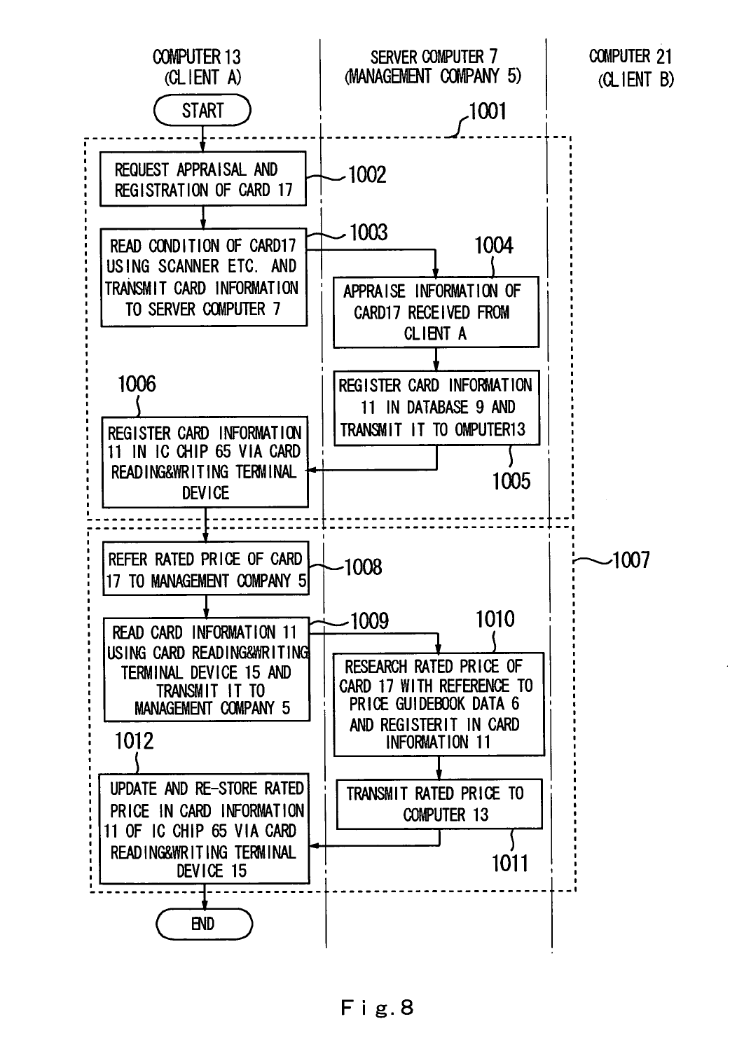

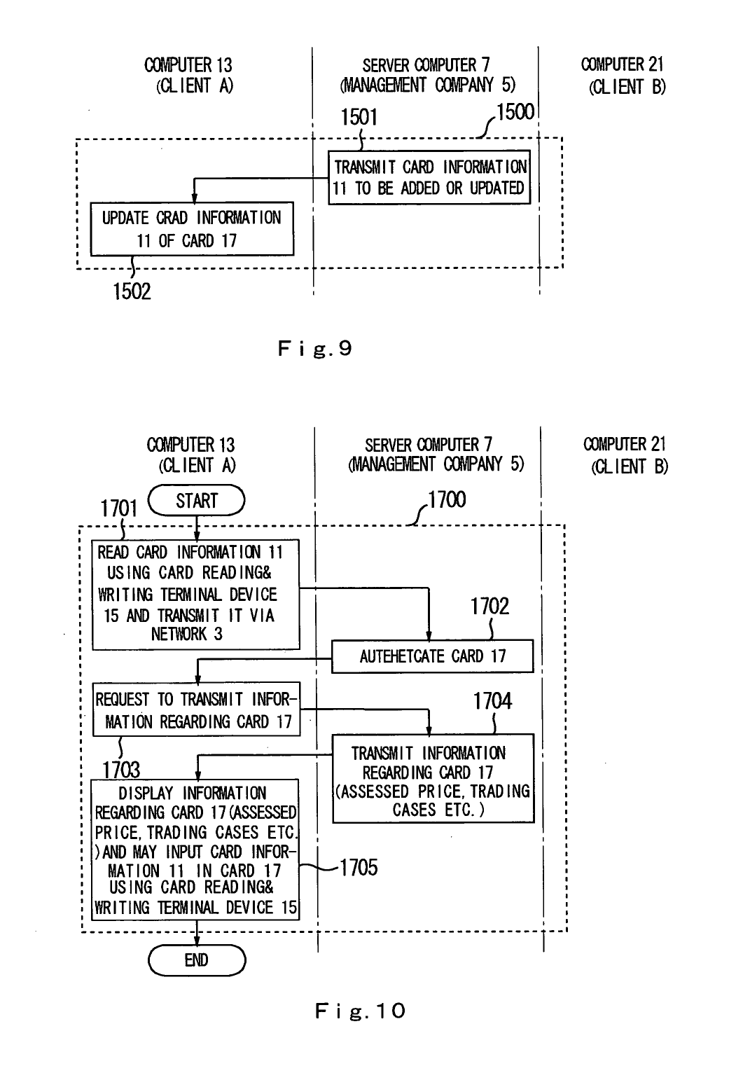

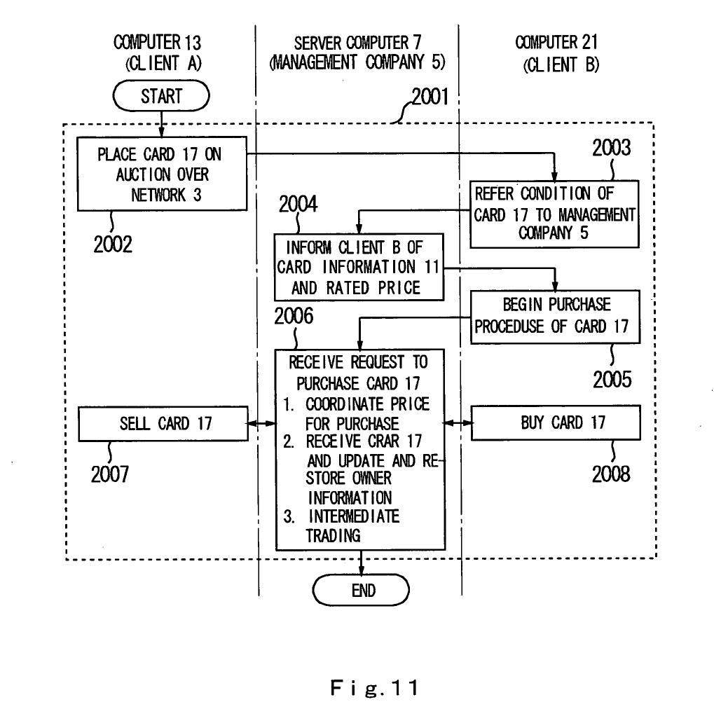

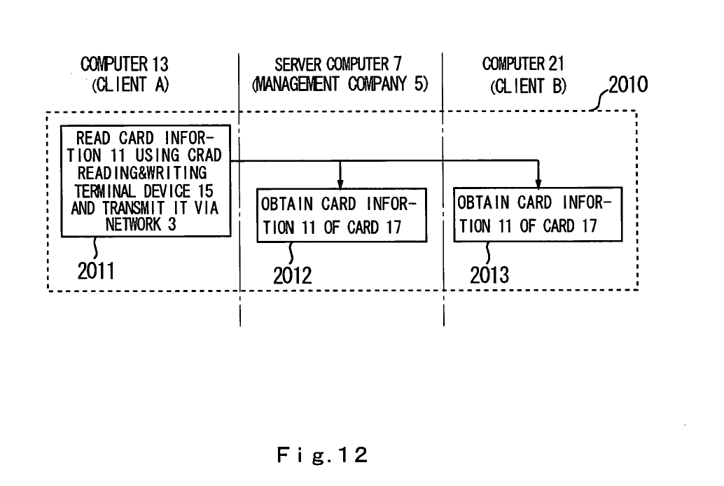

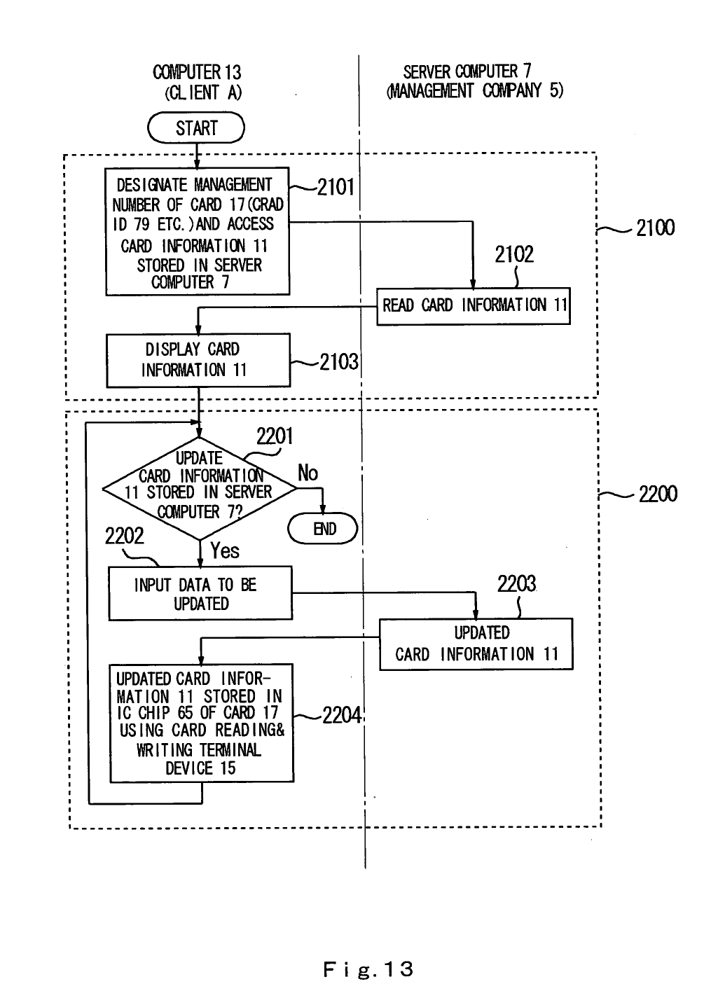

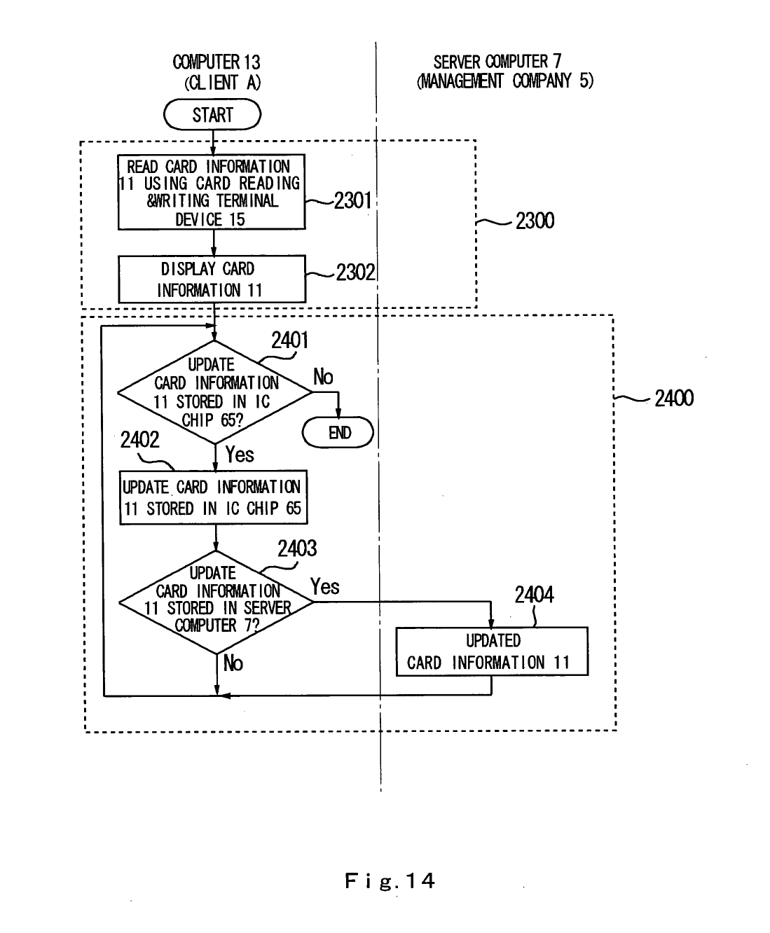

Next, appraising a card, evaluating a card, communicating card information 11, trading etc. will be described using FIG. 8 to FIG. 14. FIG. 8 is a flowchart showing the storage of an appraisal result, and the storage of a rated price of the card 17. FIG. 9 is a flowchart showing the updating of the card information 11 performed by the server computer 7. FIG. 10 is a flowchart showing the transmission of the card information 11 at the request of a client A. FIG. 11 is a flowchart showing the trading of the card 17. FIG. 12 is a flowchart showing the tranmission of the card information 11 from a client A. FIG. 13 is a flowchart showing the process of referring and updating the card information 11 in a server computer 7 by a client computer 13 of a client A. FIG. 14 is a flowchart showing the process of referring and updating the card information 11 stored in the IC chip 65 of the card 17 by a client computer 13 of the client A who owns the card 17.

(2-1. The Storage of the Appraisal Result of the Card 17 and the Storage of the Rated Price)

FIG. 8 shows the storage of the appraisal result of the card 17 (step 1001) and the storage of the rated price (step 1007). The client A requests the management company 5 to appraise and store the card 17. The control portion 41 of the client computer 13 sends the appraisal request of the card 17 to the server computer 7 of the management company 5 via the network 3 (step 1002). At the same time when asking the request for appraisal, the control portion 41 inform the server computer 7 of the private information such as the name, the address, the e-mail address etc. of the client A.

Next, the control portion of the client computer 13 sends the condition (the data by which the conditions of the center, the corners, the edges and the surfaces of the card 17 can be judged) of the card 17 read by a scanner etc. to the server computer 7 of the management company 5 via the network 3 (step 1003). Previously, the client A brought or sent by mail the card 17 to the management company 5 to request the appraisal.

The control portion 25 of the server computer 7 receives the appraisal request of the card 17 from the client A and the condition data of the card 17, analyzes the data, and appraises the card 17 (step 1004). If the appraisal is impossible due to the inperfection of the received condition data of the card 17, the client A may be asked to bring or send by mail the card 17 as before.

The control portion 25 of the server computer 7 stores the card type of the card 17, the private information of the client A (the name, the address, the e-mail address etc.), the appraisal result of the card 17 (the evaluation point appraising the card score 83, the center score 85, the corner score 87, the edge score 89 and the surface score 91) etc. as the card information 11 in the database 9; and further at the sametime transmits the card information 11 to the client computer 13 of the client A (step 1005).

The control portion 41 of the client computer 13 receives the card information 11 and stores the card information 11 in the IC chip 65 via the card reading&writing terminal device 15 (step 1006). Moreover the management company 5 may send a seal 67 including the card type, the evaluation point of the appraisal result etc., each necessary for checking the card 17 to the client A.

Here assumes that the client A holds the card 17 and the IC chip 65, each in the card case 57; or that the client A holds the card 17 having the built-in IC chip 65, however if the client A holds only the card 17 without the built-in memory portion such as the IC chip 65 etc., the management company 5 may send the IC chip 65 stored with the card information 11, the card case 57, and the seal 67 etc.

Next, storing the rated price of the card (step 1007) will be described. The client A refers the rated price (the assessed price) of the card 17 of his/her own to the management company 5, i.d. the control portion 41 of the client computer 13 transmits the request to research the rated price of the card 17 to the server computer 7 via the network 3 (step 1008). The control portion 41 of the client computer 13 transmits the card information 11 to the server computer 7, making the card information 11 read by the card reading&writing terminal device 15 (step 1009). Without reading and transmitting the card information, the server computer 7 can obtain the card information 11 of the card 17 stored in the database 9 by the information of the client A (e.g. by the owner's name 95 and the card ID 79 of the card 17) from the control portion 41 of the client computer 13.

The control portion 25 of the server computer 7 checking the rated price of the card 17 based on the data 6 of the price guidebook periodically published by the card type; and the card information of the card 17 to store the said rated price as the assessed card price 93 in the card information 11 of the database 9.

The control portion 25 of the server computer 7 transmits the rated price (the assessed price) of the card to the client computer of the client A (step 1011).

The control portion 41 of the client computer 13 stores adding or updating the rated price (the assessed price 93) of the card in the card information 11 of the IC chip 65 via the card reading&writing terminal device 15 (step 1012). The control portion 41 of the client computer 13 may store the card information 11 of the card 17 owned by the client A in the memory portion 43 of the computer 13, i.d. the client A can update the card information 11 whenever favorable.

As described above, the client A can refer the rated price (the assessed price) of the card 17 to the management company 5 via the network 3 to store the result in the IC chip 65 of the card 17 of his/her own, attenuate the labor to research the rate price on the respective occasion of the publication of a price guidebook.

However not shown in the figure, If the client A holds plural cards, the server computer 7 can with ease build the system to calculate and inform the sum of the rated prices etc. of the plural cards instantaneously by making the card reading&writing terminal device read the plural cards.

(2-2. The Updating of the Card Information 11)

FIG. 9 shows the processing (step 1500) of adding or updating the card information 11 stored in the card 17 of the client A (the owner of the card) periodically performed by the control portion 25 of the server computer 7, i.d. the management company 5 can provide the owner of the card with the given information at the request of the owner of the card on the instant basis. The owner of the card may make the display portion of the client computer 13 display the given information to check the given information, and update the card information according to the necessity.

The management company 5 obtains, for example, the said price guide data 6 periodically by the card type. The rated price of the card is updated periodically, therefore the server computer 7 updates the rated price (the assessed price 93 of the card) stored in the database 9; and at the same time transmits the card information 11 periodically added or updated in the client computer 13 of the client A (step 1501).

The control portion 41 of the client computer 13 receives the card information 11 of the transmitted card 17 to store in the memory portion 43. The card information 11 memorized in the IC chip 65 is updated when the client A holds up the card 17 (the IC chip 65) over (or inserts the card 17 into) the card reading&writing terminal device 15 (step 1502).

When the auditory information such as a message of a professional athlete whose picture is on the card 17 is stored in the IC chip 65, if the auditory information is updated periodically, the process is the same as described above. When the textual information, the animated pictures, and the still pictures are stored in the IC chip 65, it is possible to update the textual information, the animated pictures, and the still pictures can be updated periodically, the same as described above.

(2-3. The Transmission of the Card Information 11 at the request of the Client A)

FIG. 10 shows the process (step 1700) that a client A requests the management company 5 for the card information 11 to be transmitted.

The control portion 41 of the client computer 13 reads the card information 11 of the card 17 by use of a card reading&writing terminal device 15, and transmits the card information 11 of the card 17 to the server computer 7 via the network 3 (step 1701).

The control portion 25 of the server computer 7 authenticates the card 17 based on the received card information 11 (step 1702). The control portion 25 of the server computer 7 may make the server computer 7 recognize the card 17 or the client A by transmitting the client information, and the card information stored in the memory portion 27 without reading the card information 11 of the card 17 by use of the card reading&writing terminal device 15.

The control portion 41 of the client computer 13 requests the server computer 7 for transmitting the information of the card 17. The information of the card 17 is, for example, the assessed price of the card 17 or the information of the trading examples of the same card type etc.

The control portion 25 of the server computer 7 transmits the requested information of the card 17 to the client computer 13 (step 1704).

The control portion 41 of the client computer 13 makes the display portion 53 display the information of the card 17, updates the card information 11 stored in the memory portion 27, and input the card information 11 in the IC chip 65 of the card 17 by use of the card reading&writing terminal device 15 (step 1705).

(2-4. The Flowchart for Trading the Card 17)

FIG. 11 is a flowchart showing the trading processing of the card 17 by the grading system 1 (step 2001). The client A—who wishes to sell the card 17—places the card 17 on the auction on the network 3. The control portion 41 of the client computer 41 places the card 17 wished to be sold on the auction over the network 3 (step 2002). We assume that the client B finds the card 17 placed on the auction, and considers to purchase the card 17. The client computer 21 of the client B requests the server computer 7 of the management company 5 to provide the information of the condition of the card 17 (the card information 11)(step 2003). In this case the client computer 21 informs the server computer 7 of the personal information (the name, the address, and the e-mail address) of the client B.

The server computer 7 provides the client computer 21 of the client B with a portion or the entirety of the card information 11 of the card 17, and the information of the rated price (the assessed price) (step 2004).

The client B understands the card information 11 and wishes to buy the card 17. Specifically the client computer 21 of the client B informs the server computer 7 of the request to buy the card 17 and begins the procedure to buy the card 17 (step 2005).

The server computer 7 receives the request from the client computer 21 (the client B) to purchase the card 17, and begins the purchase procedure of the card 17 (step 2006). Specifically the server computer 7 coordinates the purchase price between the client computer 13 of the client A and the client computer 21 of the client B. The trading of the card 17 is established at the point when both parties agree on the conditions of trading after the client computer 13 of the client A transmits the notice to sell the card 17 (step 2007) and the client computer 21 of the client B transmits the notice to buy the card 17 (step 2008).

The management company 5 receives the card case 57 in which the card 7 is accommodated from the client A. The server computer 7 changes and re-store the owner information stored in the IC chip 65 and the database 9. Moreover the management company conducts intermediation of the payment from the dent B to the client A.

In the FIG. 11 the client A places in person the card 17 on the auction over the network, however the client A can request the management company 5 to sell the card 17. In this case the management company 5 provides the trading information of the card 17 on the webpage of the management company 5 to collect purchase aspirants.

(2-5. The Transmission of the Card Information 11 from the Client A)

Next, FIG. 12 is a flowchart showing the processing to transmit the card information 11 etc. from the client computer 13 of the client A via the network 3 (step 2010). The control portion 4 of the client computer 13 reads the card information 11 of the card 17 using the card reading&writing terminal device connected to the computer 13, and transmits the card information 11 of the card 17 to the terminal device (the server computer 7 or the client computer 21 of the client B) designated via the network 3 (step 2011).

The server computer 7 of the management company 5 obtains the card information 11 of the card 17 (step 2012). Moreover the client computer 21 of the client B also obtains the card information 11 of the card 17 (step 2013).

As described above, the card information 11 of the card 17 can be transmitted from the source of the client computer of the client A to the given terminal device by installing the card reading&writing terminal device 15 on the side of the client A. Specifically the information can be exchanged immediately with the client B who wishes to buy the card.

(2-6. The Processing of Reference and Updating by the Client A Regarding the Card Information 11 Stored in the Server Computer 7)

Next, FIG. 13 is a flowchart showing the processing of the client computer 13 of the client A to read (step 2100) and update (step 2200) the card information 11 stored in the server computer 7. Some portion of this flowchart overlaps the above-described processing, however in the processing in this flowchart, the client A can read and update the card informtion 11 of the card 17 from the server computer 7 by designating the management number of the card 17 (the card ID 79) and the client number without reading and transmitting the information stored in the IC chip 65 of the card 17 of his/her own.

The control portion 41 of the client computer 13 designates the management number of the card 17 (the card ID 79) and the client number and makes an access to the card information 11 stored in the server computer 7 (step 2101).

The control portion 25 of the server computer 7 authenticates the client computer 13 or the client A (can also authenticate by a password etc.), reads a portion or the entirety of the card information 11 of the designated card 17, and transmits the read information to the client computer 13 (step 2102).

The control portion 41 of the client computer 13 make the display portion display the transmitted card information 11 (step 2103). The card information managed by the server computer 7 can be provided with the classified rank according to the item impossible to be read by the client. For example, by this classification, the client A cannot read the personal information of the past owner.

Subsequently, the processing (step 2200) of the client computer of the client A to update the card information 11 stored in the server computer 7 is described. If the client A does not update the displayed card information 11 in the server computer 7 (the “NO” process in the step 2201), the processing will be finished. If the client updates the card information 11 stored in the server computer 7 (the “Yes” process in the step 2201), the control portion 41 of the client computer 13 receives the data to be updated from the input portion 49 (step 2202) and transmits the received data to the server computer 7.

The client A can update the data of the personal information etc. of the client A (e.g. the owner's name 93 and the contact information etc.), however, for example, cannot update from the client computer 13 of the client the card score 83 which is the item of the card 17, and the assessed card price 93.

The control portion 25 of the server computer 7 updates the card information 11 stored in the database 9 based on the data to be updated transmitted from the client computer 13 (step 2203).

When the card information 11 stored in the database 9, and the card information 11 stored in the IC chip 65 of the card 17 owned by the client A should agree with each other, the control portion 41 of the client computer 13 updates the card information 11 stored in the IC chip 65 of the card 17 by use of the card reading&writing terminal device 15 (step 2204), goes back to the step 2201, and repeats the updating processing.

As described above, the client A can refer and update the card information 11 stored in the server computer 7 from the client computer 13 of his/her own.

(2-7. The Processing of Reference and Updating Regarding the Card Information 11 of the Card 17 Owned by the Client A)

Next, FIG. 14 is a flowchart showing the processing of the client computer 13 of the client A to read the card information 11 stored in the IC chip 65 of the card 17 of his/her own (step 2300), and to update the read information (step 2400). Specifically, the client A can read and update the card information 11 stored stored in the IC chip 65 of the card 17 of his/her own immediately without using the server computer 7.

First, the control portion 41 of the client computer 13 reads the card information 11 stored stored in the IC chip 65 of the card 17 of his/her own via the card reading&writing terminal device 15 (step 2301).

The control portion 41 of the client computer 13 make the display portion 53 display the read card information 11 (step 2302). Therefore the client A can read the card information 11 of the card 17 of his/her own without connecting to the server computer 7 etc. Moreover the owner of the card 17 can check in person if the card information is illegally altered or not, for it is possible to read the card information 11 stored in the server computer 7 by performing the step 2100 shown above in FIG. 13.

The card information managed by the server computer 7 and the card information stored in the IC chip 65 do not agree with each other necessarily. For example the IC chip 65 of the card 17 can be provided with the proper information memory area of the owner of a card. The card information stored in the IC chip 65 of the card 17 may include the item impossible to be read by the client. For example, by this classification, the client A cannot read the personal information of the past owner.

Subsequently, the processing of the client computer 13 of the client A to update the card information 11 stored in the IC chip 65 of the card 17 (step 2400) will be described. If the client A does not update the card information 11 in the IC chip 65 of the card 17 (the “NO” process of the step 2401), the processing will be finished. If the client A updates the card information 11 stored in the IC chip 65 of the card 17 (the “YES” process of the step 2401), the control portion 41 of the client computer 13 receives the input of the data to be updated from the input portion 49, and updates the card information 11 stored in the IC chip 65 of the card 17 (step 2402).

If the card information 11 in the server computer 7 is updated in accordance with the updating of the card information 11 in the IC chip 65 (the “YES” process of the step 2403), the control portion 25 of the server computer 7 updates the corresponding card information 11 in the database 9 (step 2404) and the process goes back to the step 2401. For example, if the item of the personal information of the client A (the address or the contact information etc.), the card information 11 in the server computer 7 is updated in accordance with the updating of the card information 11 in the IC chip 65.

If the card information 11 in the server computer 7 is not updated, the process goes back to the step 2401 and the updating processing is repeated. For example, the visual information personally obtained by the client A and the personal textual infromation etc., which the server computer 7 need not manage, can be stored in the card information in the IC chip 65.

As described above, the client A can refer and update the card information 11 of the card 17 of his/her own via the card reading&writing terminal device by use of the client computer 13 of his/her own.

(3. Accounting)

In the practice form of the grading system 1 of the present invention, the client A pays the appraisal fee of the card 17, the registry fee of the card information 11, and the fee for the card case 57 and the IC chip 65 to the management company 5.

The client B pays the fee for the information reference of the card 17 to the management company 5. If the client B purchases the card 17, the client B pays the price of the card 17 to the client A. If the card 17 is not included in the card case 57, the client B can obtain the card 17 accommodated in the card case 57 by paying the price.

Either the client A or the client B who requests the management company 5 to intermediate the card trading pays intermediation fee to the management company 5.

The management company 5 may collect the management fee for the card information 11 from the client A.

(4. Other Descriptions)

The card 17 may be provided with the built-in memory medium such as the IC chip 65 etc. The transparent pouched card sleeve, the team bag, and the case such as the top loader whose upper side can be opened etc. may be provided with the built-in memory medium such as the IC chip 65 etc.

In the above-described case, the card 17 may be coated with the material to attenuate ultraviolet rays. The card sleeve may be provided with the material to attenuate ultraviolet rays. There is a chemical substance to change ultraviolet ray cut ratio according to the outer brightness (the quantity of ultraviolet rays), the same as a changeable lens. In some cases this chemical substance is added to the material when making the card 17 or the card sleeve etc. to change the material itself, or provided with the coating processing on the surface or the sealing processing. The material can be powderlike, creamlike, liquid etc.

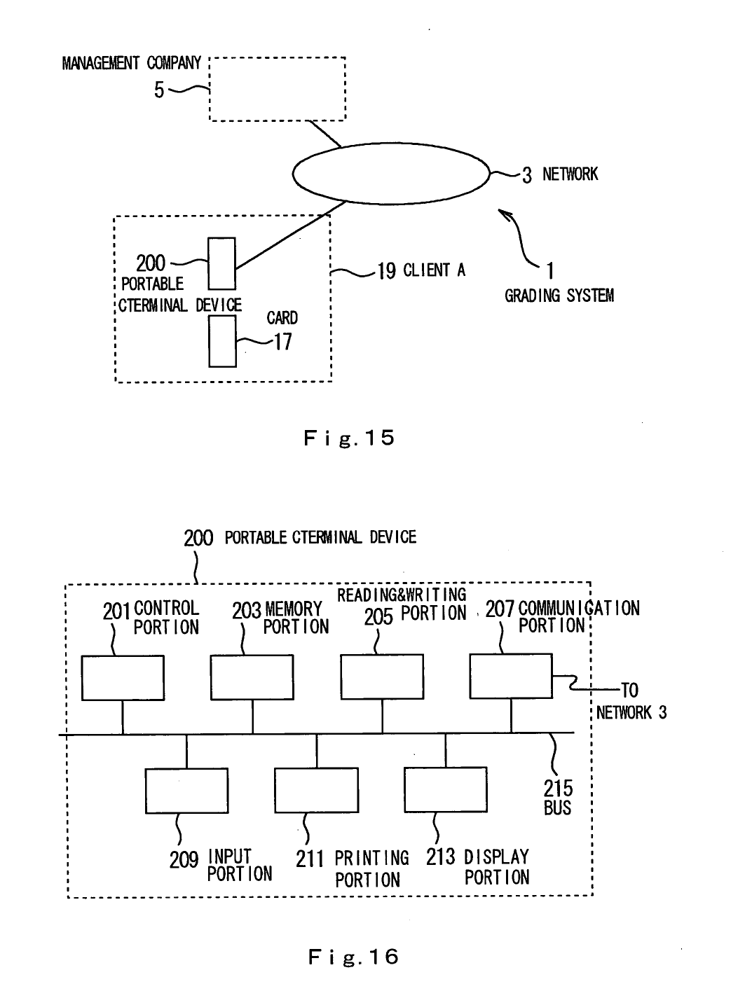

The client A can use the portable terminal device 200 as the communication terminal with the management company other than the above-described desk-top computer 13. FIG. 15 is a block diagram showing the grading system 1 by use of the portable terminal device 200. FIG. 16 is a block diagram showing the configuration of the portable terminal device 200.

The portable terminal device 200 is such as a cellular phone, a PDA (Personal Digital Assistant) or a hand-held computer etc., and can be connected to the management 5 via the network 3. Among the configuration of the portable terminal device 200, the control portion 201, the memory portion 203, the communication portion 207, the input portion 209, the display portion 211 and the bus 215 which are common with those of the client computer 13 shown in the FIG. 3 are omitted.

The portable terminal device 200 is provided with the built-in reading&writing portion 205 to read the IC chip 65 of the card 17. The reading&writing portion 205 is, in case of a non-contact type, the I/O (input/output) portion by use of the infrared I/O portion or the laser diode. The reading&writing portion 205 can be a contact-type terminal.

The I/O portion 213 is, for example, the extendible portion such as a terminal connected to the printing device such as a printer etc., a terminal connected to another desk-top computer, or a terminal connected to another reading&writing terminal device for the card 17.

The function of the portable terminal device 200 is the same as that of the above-described client computer 13. Therefore the portable terminal device 200 works the same as the client computer 13 shown in the flowcharts from FIG. 8 to FIG. 14.

(5. Effects and etc.)

In the practice form of this invention, the appraisal time can be shortened even if an owner of a card and the management company 5 are distant from each other, because the owner of a card can request the appraisal of the card 17 of his/her own via the network 3. In the practice form of this invention the risk of a trouble (the loss or damage of a card) in case of sending the card by mail to the management company 5 for appraisal can be avoided. An owner of a card can read the card information 11 by holding up the card 17 over the card reading&writing terminal device 15. The owner of a card can request the transmission of the trading cases of the same card type or other card information from the server computer 7 on demand. For example without researching the rated price of the card in the periodically published price guidebook of the card 17, the owner of a card can with ease updated the assessed card price 93 in the card information 11 by requesting the management company 5 to update the rated card price (the assessed card price 93).

The owner of a card can refer and update the card information 11 stored in the server computer 7 if the server computer authenticates the card management number and the client number etc., without using the card reading&writing terminal device to read the card 17.

An owner of a card can refer the card information 11 stored in the IC chip 65 of the card 17 by using the card reading&writing terminal device 15 in the client computer 13, and update the card information 11. Therefore the owner of a card can read the card information 11 stored in the server computer 7 and the card information 11 stored in the IC chip 65 of the card 17; compare the content of the card information 11; and check the right storage of data.

An owner of a card can input data in the IC chip 65 of the card 17 directly from the client computer 13 etc. of his/her own, therefore the owner of a card can input the visual information or the textual information in the IC chip 65 as a memorandum to make an original card 17. It is desirable for the management company 5 etc. to delete the personal information stored in the IC chip 65 before the trading the card 17 and the transfer of the card 17.

By use of the portable terminal device 200, the client A can transmit and receive the information of the card 17 without limitation of the specific location.

Through the intermediation by the card company 5 in the card trading, the safe and fair card trading can be established.

Obviously, numerous modifications and variations of the present invention are possible in light of the above teachings. It is therefore to be understood that within the scope of the appended claims, the present invention may be practiced otherwise than as specifically described herein.

1. A grading system, comprising:
a server computer connected to a network; and
a client computer connected to the network provided with a card reading&writing terminal device, wherein
the server computer includes means to receive an appraisal result of the card transmitted from the client computer making the card reading&writing terminal device read the card; and means to transmit a rated price of a card judged from the appraisal result of the card to the client computer and input the rated price in the client computer by use of the said card reading&writing terminal device.

2. A grading system, comprising;
a server computer connected to a network; and
a client computer connected to the network provided with a card reading&writing terminal device, wherein
the server computer includes means to appraise the card based on the information regarding the condition of the card; and means to transmit an appraisal result to the client computer and input in the card by use of the reading&writing terminal device.

3. A grading system according to claim 1 or claim 2, wherein the server computer includes
a means to transmit the card information to be added or updated in the client computer via the network; and
a means to input the card information in the card via the card reading&writing terminal device.

4. A grading system according to claim 1 or claim 2, wherein the server computer includes
a means to authenticate the card read from the card reading&writing terminal device; and
a means to transmit the card information to the client computer at the request of the client computer.

5. A grading system, comprising;
a server computer connected to a network; and
a client computer connected to the network provided with a card reading&writing terminal device, wherein
the server computer transmits an appraisal result of a card etc. at the request of the first client computer of an aspirant to buy a card for the information reference regarding the card, and intermediates the trading by informing the second client computer of an owner of the card at the request of the first client computer for buying the card, and
when the trading of the card is established and the ownership of the card is changed, updates and stores the owner information of the card.

6. A grading system, comprising;
a server computer connected to a network; and
a client computer connected to the network provided with a card reading&writing terminal device, wherein
the client computer includes
a means to read the information regarding a card stored in the server computer; and
a means to update and add the information regarding the card stored in the server computer.

7. A grading system, comprising;
a server computer connected to a network; and
a client computer connected to the network provided with a card reading&writing terminal device, wherein
the client computer includes
a means to read the information stored in the card; and
a means to update and add the information stored in the card.

8. A grading system according to either from claim 1 to claim 7, wherein
the card stores the appraisal result of the card, the owner information of the card, the rated price of the card, and other inforamtion regarding the card.

9. A grading system according to either from claim 1 to claim 7, wherein
the server computer stores in the memory portion the appraisal result of the card, the owner information of the card, the rated price of the card, and other inforamtion regarding the card.

10. A server computer connected to a client computer provided with a card reading&writing terminal device via a network wherein
the server computer includes
a means to receive an appraisal result of the card which the client computer of an owner of a card reads via the card reading&writing terminal device and transmits; and
a means to transmit the rated price of the card judged from the appraisal result of the card to the client computer and to input in the card by use of the card reading&writing terminal device.

11. A server computer connected to a client computer provided with a card reading&writing terminal device via a network wherein
the server computer includes a means to appraise a card based on the information regarding the condition of the card; and
a means to transmit an appraisal result to the client computer of an owner of the card and to input the appraisal result in the card by use of the card reading&writing terminal device.

12. A server computer according to claim 10 or claim 11 wherein
the server computer includes
a means to transmit the card information to be added or updated to the client computer via the network; and
a means to make the client computer input the card information in the card via the card reading&writing terminal device.

13. A server computer according to claim 10 or claim 11 wherein
the server computer includes
a means to authenticate the card read via the card via the card reading&writing terminal device by the client computer; and
a means to transmit the information of the card to the client computer at the request of the client computer.

14. A server computer connected to a client computer of an aspirant to buy a card and a client computer of an owner of the card via a network wherein
the server computer transmits an appraisal result of the card etc. to the first client computer at the request of the first client computer, intermediates the trading of the card by informing the second client computer of the owner of the card at the request of the first client computer for buying the card, and
when the trading of the card is established and the ownership of the card is changed, updates and stores the owner information of the card etc.

15. A client computer connected to a server computer via a network wherein the client computer includes
a means to read the information regarding a card stored in the server computer; and
a means to update and add the information regarding the card stored in the server computer.

16. A client computer connected to a server computer via a network wherein
the client computer includes
a means to read the information stored in a card; and
a means to update and add the information regarding the card stored in the card.

17. A card case, comprising:
an accommodation space for accommodating a card; and
an IC chip accommodation space for accommodating a memory medium such as an IC chip etc.

18. A card case according to claim 17 wherein
a memory medium such as an IC chip etc. stores an appraisal result of the card, the owner information of the card, the rated price of the card, and other information regarding the card.

19. A card case according to claim 17 wherein
the card case is made of the material to attenuate the ultraviolet rays radiated to the card.

20. A card provided with a memory medium such as an IC chip etc. wherein
the memory medium stores an appraisal result of the card, the owner information of the card, the rated price of the card, and other information regarding the card.

21. A card according to claim 20, coated with a material to attenuate the ultraviolet rays.

22. A program enabling a server computer to function as either grading system according to claim 1 to claim 7.

23. A grading system according to claim 1 to claim 9 wherein
the client computer provided with a card reading&writing terminal device is a portable terminal device with the card reading&writing terminal device.

24. A server computer according to claim 10 to claim 16 wherein
the client computer provided with a card reading&writing terminal device is a portable terminal device with the card reading&writing terminal device.

25. A client computer according to claim 15 or claim 16 wherein
the client computer provided with a card reading&writing terminal device is a portable terminal device with the card reading&writing terminal device.
